(19) United States
(12) Patent Application Publication
(10) Pub. No.: US 2009/0198486 A1
(43) Pub. Date: Aug. 6, 2009

(54) HANDHELD ELECTRONIC APPARATUS WITH TRANSLATION FUNCTION AND TRANSLATION METHOD USING THE SAME

(75) Inventor: SHIH CHIEH CHANG, HSINCHU CITY (TW)

Correspondence Address: WPAT, PC;INTELLECTUAL PROPERTY ATTORNEYS, 2030 MAIN STREET, SUITE 1300, IRVINE, CA, 92614, US

(73) Assignee: NATIONAL TSING HUA UNIVERSITY, HSINCHU (TW)

(21) Appl. No.: 12/026,506

(22) Filed: Feb. 5, 2008

(51) Int. Cl. G06F 17/28; G06K 9/20

(52) U.S. Cl. 704/2; 382/321

(57) ABSTRACT

A handheld electronic apparatus with a translation function comprises an image-capturing device, an image recognition device, a language translator and a display device. The image-capturing device, e.g., a digital camera, is configured to take an image having a text portion of one or more words or sentences, and the image may be shown on the display device. The image recognition device is configured to recognize the text portion to be in a first language. For example, the recognition uses optical character recognition (OCR) technology. The language translator is configured to translate the text portion in the first language into a second language, and the text portion in the second language is shown on the display device.

### BACKGROUND OF THE INVENTION

(A) Field of the Invention

The present invention relates to a handheld electronic apparatus, and more particularly, to a handheld electronic apparatus with a translation function and the translation method using the same.

(B) Description of the Related Art

To ease the reading or understanding of a non-native written language, an electronic translator can translate words or even sentences from one language to another. There are many ways to input to a translator such as typing on a keypad or writing on a touch pad. There also exist more friendly ways of inputting to a translator such as scanning the written words or sentences. When documents are properly printed or designed, the recognition of a character or sentence is very accurate. However, typing, writing on a touch pad or scanning is still very inconvenient and troublesome for a user. For example, to type a word, a user must be familiar with the particular position of a character; and for scanning, the font must have an appropriate size so that a handheld scanner can operate. In some cases, a user may not know how a foreign word is typed or written into a translator. For example, when traveling to a foreign country whose language is not understood by the user, the user cannot type in the character.

Some handheld electronic apparatuses such as mobile phones with digital cameras or digital cameras are very popular now, and people usually carry them during personal or business travels. Therefore, if the handheld electronic apparatus can provide an effective translation function, a user can easily travel in a foreign country or in an environment containing foreign languages.

### SUMMARY OF THE INVENTION

The present invention is directed to providing a handheld electronic apparatus, e.g., a digital camera, a mobile phone, a personal digital assistant (PDA) or the like, to translate languages and the translation method using the same, so that it is very convenient to a user traveling abroad or in some environments in which foreign words or sentences occur.

In accordance with the present invention, a handheld electronic apparatus with a translation function comprises an image-capturing device, an image recognition device, a language translator and a display device. The image-capturing device, e.g., a digital camera, is configured to capture an image having a text portion of one or more words or sentences, and the image may be shown on the display device. The image recognition device is configured to recognize the text portion to be in a first language. In an embodiment, the recognition uses optical character recognition (OCR) technology. The language translator is configured to translate the text portion in the first language into a second language, and the text portion in the second language is shown on the display device.

In brief, the translation comprises the following steps: (1) capturing an image having a text portion with the image-capturing device; (2) recognizing the text portion to be in a first language by using the image recognition device; (3) translating the text portion in the first language into a second language with the language translator; and (4) showing the text portion in the second language on the display device.

In an embodiment, the handheld electronic apparatus may be a mobile phone with a digital camera or a digital camera with the translation function. Accordingly, a user can use the mobile phone or the digital camera to easily read a menu in a restaurant, to recognize a street name, or even to read complicated signs. In addition, a student can use this device to make a fast translation when trying to learn another language.

### BRIEF DESCRIPTION OF THE DRAWINGS

The objectives and advantages of the present invention will become apparent upon reading the following description and upon reference to the accompanying drawings in which:

FIG. 1 through FIG. 3 illustrate a handheld electronic apparatus with a translation function in accordance with an embodiment of the present invention; and

FIG. 4 illustrates a functional block diagram of the handheld electronic apparatus in accordance with an embodiment of the present invention; and

FIG. 5 illustrates a flow chart of the translation method in accordance with an embodiment of the present invention.

### DETAILED DESCRIPTION OF THE INVENTION

Although there are several ways to input characters to a translator such as typing, writing on a touch screen, or scanning with an optimal scanner, all of them are inconvenient to a user. The present invention uses a digital camera or a handheld electronic apparatus embedded with a digital camera to capture an image, and the image is recognized and translated, thereby providing effective and convenient language translation.

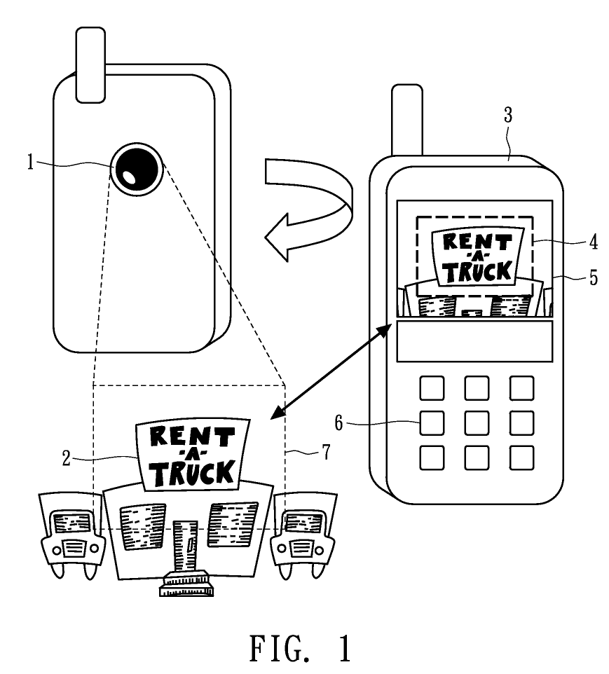

FIG. 1 illustrates a handheld electronic apparatus 3, for instance, a mobile phone 3 is provided with an image-capturing device 1 such as a digital camera on the back, and the digital camera 1 may use CMOS or CCD as an image light-sensitive sensor. When a user attempts to understand a shop sign 2, “Rent a Truck,” he or she captures an image 7 including the shop sign 2 with the digital camera 1, and the image 7 is then shown on a display device, i.e., a screen 5, of the mobile phone 3. A frame 4 is employed to confine the text portion including one or more words or phrases, i.e., “Rent a Truck” in this embodiment, and then the frame 4 will be scanned by, for example, optical character recognition (OCR) technology to recognize that the meaning of the shop sign 2 is “Rent a Truck” in English.

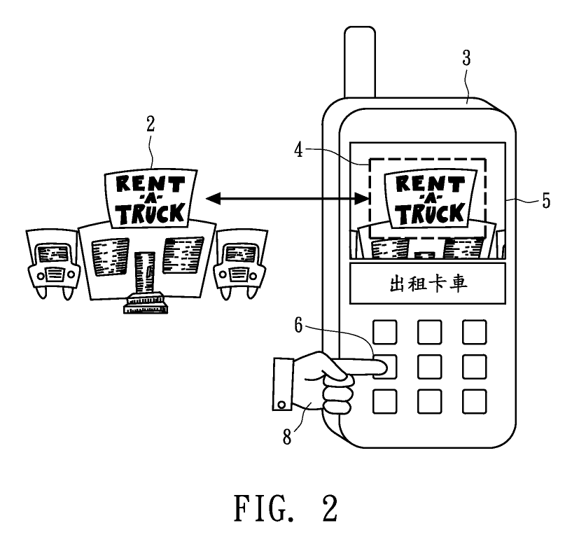

For example, in FIG. 2, when the frame 4 confines the shop sign 2 “Rent a Truck,” a user 8 can input a command through a button 6 on the mobile phone 3 so as to translate “Rent a Truck” into other languages such as Chinese on the screen 5. In other words, the word or sentence confined by the frame 4 is translated into another language understood by the user 8, and the Chinese translation is shown on the screen 5.

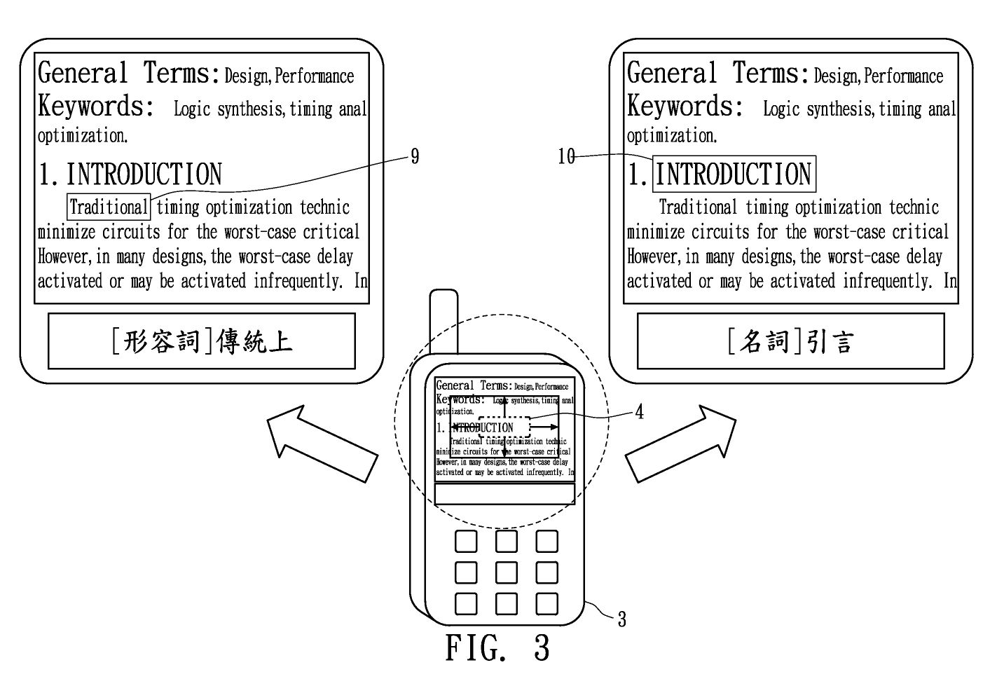

In one embodiment, the frame 4 is adjustable and moveable in order to have a size and a location that comply with the text portion to be translated, as shown in FIG. 3. Accordingly, a word 9 and a word 10 of different sizes can be selected for recognition and translation.

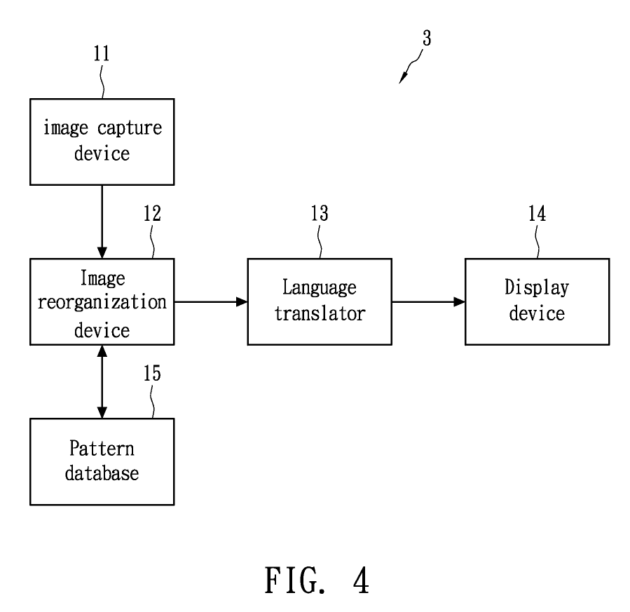

FIG. 4 illustrates a functional block diagram of the mobile phone 3, which comprises an image-capturing device 11, an image recognition device 12, a language translator 13, a display device 14 and a pattern database 15. The image-capturing device 11 captures an image including the text portion to be recognized, and the image is transmitted to the image recognition device 12. The image recognition device 12 can retrieve the pattern database 15 in order to recognize one or more words or sentences in the text portion, and the text portion is translated by the language translator 13. The translated words or sentences are shown on the display device 14. A new pattern acquired by the image recognition device 12 can be stored in the pattern database 15.

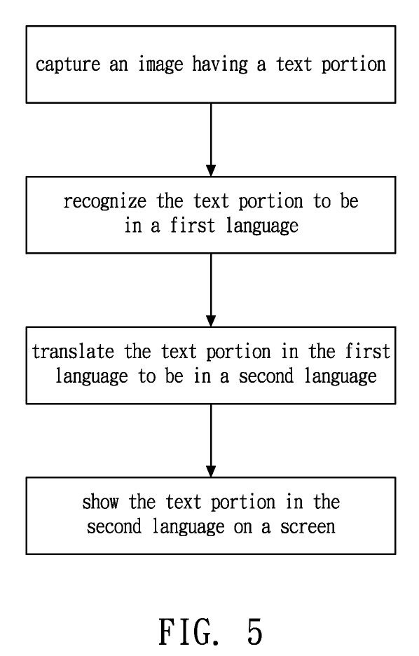

In brief, the present invention proposes a method as shown in FIG. 5. First, a user uses a handheld electronic apparatus with a digital camera to capture the image having a text portion. Next, the text portion is recognized to be in a first language, and the text portion in the first language is translated into a second language. Then, the translation result is shown on a screen.

The present invention uses a digital camera to capture an image of words or sentences of a foreign written language, and the built-in translator and character recognition device translate the words or phrases into another language. The resulting translation can be shown on the camera or handheld electronic apparatus's screen immediately. With this capability, in a foreign country, a user can use a digital camera or a mobile phone with a digital camera to read a food menu, to recognize street name, or even to read complicated signs. In addition, a student can use this utility to make fast translation when trying to learn another language.

The above-described embodiments of the present invention are intended to be illustrative only. Numerous alternative embodiments may be devised by those skilled in the art without departing from the scope of the following claims.

What is claimed is:

1. A handheld electronic apparatus with a translation function, comprising:
an image-capturing device configured to capture an image having a text portion;
an image recognition device configured to recognize the text portion to be in a first language;
a language translator configured to translate the text portion in the first language into a second language; and
a display device configured to show the text portion in the second language.

2. The handheld electronic apparatus of claim 1, wherein the image recognition device uses optical character recognition (OCR) technology.

3. The handheld electronic apparatus of claim 1, wherein the image-capturing device is a digital camera.

4. The handheld electronic apparatus of claim 1, wherein the text portion of the image is confined by a frame in order to be recognized.

5. The handheld electronic apparatus of claim 4, wherein the frame has an adjustable size.

6. The handheld electronic apparatus of claim 1, further comprising a pattern database for recognizing the text portion to be in the first language.

7. A translation method using a handheld electronic apparatus including an image-capturing device, an image recognition device, a language translator and a display device, comprising the steps of:
capturing an image having a text portion with the image-capturing device;
recognizing the text portion to be in a first language by using the image recognition device;
translating the text portion in the first language into a second language with the language translator; and
showing the text portion in the second language on the display device.

8. The translation method of claim 7, wherein recognizing the image uses optical character recognition (OCR) technology.

9. The translation method of claim 7, wherein the image-capturing device is a digital camera.

10. The translation method of claim 7, wherein the text portion of the image is confined by a frame in order to be recognized.

11. The translation method of claim 10, wherein the frame has an adjustable size.
